(19) United States
(12) Patent Application Publication
(10) Pub. No.: US 2021/0293257 A1
(43) Pub. Date: Sep. 23, 2021

(54) Gas-liquid Coupling Type Fluid Pulsation Attenuator

(71) Applicants: Beihang University, Beijing (CN); Ningbo Institute of Technology, Beihang University, Ningbo City (CN)

(72) Inventors: ZONGXIA JIAO, Beijing (CN); YUANZHI XU, Beijing (CN); RENYUAN WANG, Beijing (CN)

(21) Appl. No.: 17/202,593

(22) Filed: Mar. 16, 2021

(30) Foreign Application Priority Data
Sep. 21, 2020 (CN) 2020109951760

(51) Int. Cl. F15B 1/16; F16L 55/054; F04B 11/00

(52) U.S. Cl. CPC F15B 1/165; F16L 55/054; F15B 2201/4053; F15B 2201/205; F15B 2201/3152; F04B 11/0016

(57) ABSTRACT

The present disclosure provides a gas-liquid coupling type fluid pulsation attenuator, which comprises: substrate, which is hollow and with an opening at one end; bladder, which is located at the hollow part of the substrate, and a first chamber is formed between the bladder and the inner wall of the substrate; and lining, which is located inside the bladder. The gas-liquid coupling type fluid pulsation attenuator of the present disclosure makes the fluid in the main pipe enter the first chamber through the opening of the substrate, and the bladder is filled with gas. Therefore, under the action of the pressure difference between the fluid pressure in the first chamber and the air pressure in the bladder, the bladder deforms, so as to absorb the flow pulsation through the expansion and contraction of the bladder, to make the oil flow in the hydraulic energy system more stable.

### FIELD OF THE INVENTION

The present disclosure relates to the technical filed of pulsation absorption of fluid mechanical devices, and in particular to a gas-liquid coupling type fluid pulsation attenuator.

### BACKGROUND OF THE INVENTION

At present, the fluid transmission systems, such as hydraulic system, etc., mostly use pump as energy supply device. Because of the special structure of the pump, it will inevitably create flow pulsation. In addition, liquid resistance and the flow pulsation in the pipeline system will also lead to pressure pulsation. The pressure pulsation will cause fatigue damage to the piping system and components, which will cause an adverse impact on the reliability of the system.

The present pulsation absorbing elements, such as accumulator, could not make any sense in the system with a wide change ranges of pressure and temperature, because in this condition the accumulator will reach the limiting position and lose its working ability. Therefore, the accumulator is not suitable for wide temperature and pressure applications. Moreover, most of the accumulators are large in volume and weight, which is not fitted to be installed in a narrow space. Generally, the accumulator is only capable for absorbing pulsation in the narrow frequency band within 100 Hz rather than wide frequency band.

### SUMMARY OF THE INVENTION

To solve at least one of the above technical problems, the present disclosure provides a gas-liquid coupling type fluid pulsation attenuator.

According to one aspect of the present disclosure, a gas-liquid coupling type fluid pulsation attenuator, comprising:

substrate, which is hollow and with an opening at one end;

bladder, which is located at the hollow part of the substrate, and a first chamber is formed between the bladder and an inner wall of the substrate; and

lining, which is located inside the bladder.

According to at least one embodiment of the present disclosure, the lining is provided with a through vent hole along its radial direction.

According to at least one embodiment of the present disclosure, an effective operating temperature range of the gas-liquid coupling type fluid pulsation attenuator is matched by adjusting the volume of the lining.

According to at least one embodiment of the present disclosure, an effective operating pressure range of the gas-liquid coupling type fluid pulsation attenuator is matched by adjusting the volume of the lining.

According to at least one embodiment of the present disclosure, further comprising:

connecting pipe, and one end of the connecting pipe is connected to an interior of the bladder, and the other end of the connecting pipe is connected to a plug through thread.

According to at least one embodiment of the present disclosure, both ends of the substrate are open, and an opening of one end of the substrate is sealed connected to an end of the connecting pipe far away from the bladder.

According to at least one embodiment of the present disclosure, an end of the substrate far away from the plug is extended outwards with a connecting part. The connecting part is provided with an external thread, and an end of the connecting part far away from the substrate is provided with a connecting through hole leading to the opening of the substrate.

According to at least one embodiment of the present disclosure, the bladder is made of elastic rubber.

According to at least one embodiment of the present disclosure, the bladder is made of oil resistant elastic rubber.

According to at least one embodiment of the present disclosure, the shape of the bladder is a long cylinder.

### BRIEF DESCRIPTION OF THE DRAWINGS

The drawings show exemplary embodiments of the present disclosure and, together with the descriptions thereof, are used to explain the principles of the present disclosure, which are included to provide a further understanding of the present disclosure, and are included in and form a part of this specification.

FIG. 1 is a schematic diagram of the gas-liquid coupling type fluid pulsation attenuator according to the embodiments of the present disclosure.

In the FIGURE, 1—substrate, 11—connecting part, 2—bladder, 3—lining, 31—vent hole, 4—connecting pipe, 5—plug, 6—first chamber, and 7—second chamber.

### DETAILED DESCRIPTION OF THE INVENTION

The present disclosure will be further described in detail with reference to the accompanying drawings and embodiments. It is understood that the specific embodiments described herein are only for the purpose of explaining the relevant contents, not for the limitation of the present disclosure. In addition, it should be noted that for the convenience of description, only parts related to the present disclosure are shown in the drawings.

It should be noted that the embodiments and features in the present disclosure may be combined with each other without conflict. The present disclosure will be described in detail below with reference to the accompanying drawings and in combination with embodiments.

The gas-liquid coupling type fluid pulsation attenuator of the present disclosure makes the fluid in the main pipe enter the first chamber through the opening of the substrate, and the bladder is filled with gas. Therefore, under the effect of the pressure difference between the fluid pressure in the first chamber and the air pressure in the bladder, the bladder will deforms, so as to absorb the flow pulsation through the expansion and contraction of the bladder, to make the oil flow in the hydraulic energy system more stable. It will effectively reduce fluid pulsation in wide temperature, pressure and frequency range, so as to improve the reliability of the hydraulic system.

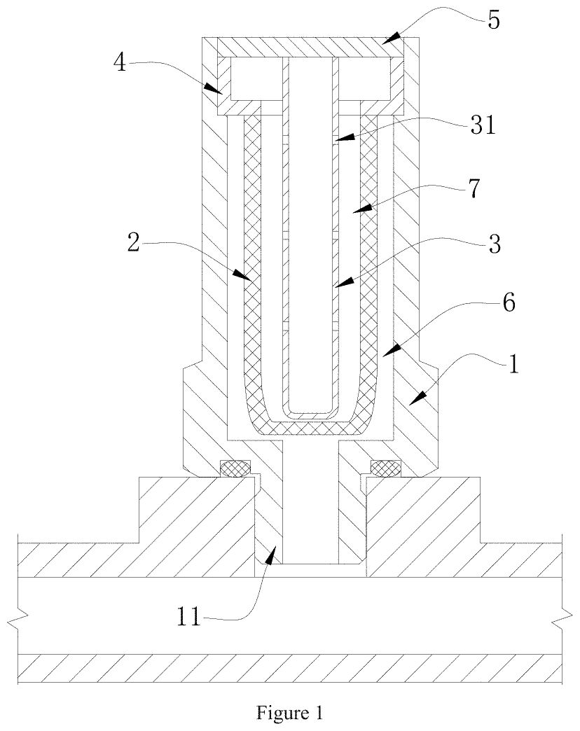

As shown in the FIG. 1, according to the first embodiment of the present disclosure, a gas-liquid coupling type fluid pulsation attenuator is provided. The gas-liquid coupling type fluid pulsation attenuator comprises:

substrate 1, which is hollow and with an opening at one end;

bladder 2, which is located at the hollow part of the substrate 1, and a first chamber 6 is formed between the bladder 2 and the inner wall of the substrate 1; and

lining 3, which is located inside the bladder 2.

The substrate 1 is configured to connect the gas-liquid coupling type fluid pulsation attenuator to the hydraulic pipeline. The substrate 1 can be connected to the hydraulic pipeline by flange connection, welding, thread connection, etc.

The bladder 2 can be realized by using existing technology. The bladder 2 can be directly placed in the hollow part of the substrate 1 or be fixed to the hollow part of the substrate 1 through an existing manner.

The lining 3 can be directly placed in the bladder 2 or be fixed on the inner wall of the bladder 2 through an existing manner.

The fluid enters the first chamber 6 through the hydraulic pipeline, and the bladder 2 deforms with the pressure difference between the fluid in the first chamber 6 and the gas in the bladder 2. When the air pressure in the bladder 2 is lower than the fluid pressure in the first chamber 6, the bladder 2 contracts, otherwise, the bladder 2 expands. The flow pulsation can be absorbed through the expansion and contraction of bladder 2, so that the oil flow in the hydraulic energy system is more stable.

In an optional embodiment of the present disclosure, the effective operating temperature range of the gas-liquid coupling type fluid pulsation attenuator is matched by adjusting the volume of lining 3, which can be explained through the following derivation.

For convenience to explain, the following second chamber 7 is the hollow part of the bladder 2.

Assuming that Vₘₐₓ is the maximum volume of the second chamber 7, at this time, the bladder 2 completely expands and fills the hollow part of the whole substrate 1. Assuming that Vₘᵢₙ is the minimum volume of the second chamber 7, at this time, the bladder 2 is fully compressed. V₁ is the actual volume of the second chamber 7 when the second chamber 7 is operating.

Before the attenuator works, at the temperature T₀, gas is filled into the second chamber 7 until the pressure of the second chamber 7 reaches P₀. At this time, the volume of the second chamber 7 is obviously Vₘₐₓ. Assuming that the gas volume of the gas-liquid coupling type fluid pulsation attenuator changes rapidly during the whole operating period, it can be considered as an adiabatic process. Therefore, formula (1) can be obtained from the Ideal Gas Law.

P₀V₀=nRT₀ (1)

Wherein, V₀ is the initial volume of the second chamber 7, and it is obviously that V₀=Vₘₐₓ. n is the amount of substance of gas, and R is the proportional constant.

When the gas-liquid coupling type fluid pulsation attenuator is connected to the system, the bladder 2 is compressed by the fluid pressure, and the volume and pressure of the second chamber 7 are changed to V₁ and P₁ respectively. If the variation of the ambient temperature is T₁, then there is also a gas formula (2).

P₁V₁=nRT₁ (2)

According to formula (1) and (2), the relationship between operating temperature and operating volume can be obtained as follows:

$${T}_{I} = \frac{{V}_{I}}{{V}_{0}} \frac{{P}_{I}}{{P}_{0}} {T}_{0} . \qquad ( 3 )$$

It can be seen from the formula (3) that the operating temperature T₁ is directly proportional to the operating volume V₁. That is, the larger the range of operating volume V₁, the larger the range of operating temperature T₁.

The variable volume of bladder 2 is defined as:

ΔV=Vₘₐₓ−Vₘᵢₙ. (4)

The variable volume of bladder 2 is the variation range of the operating volume V₁, that is, V₀−ΔV<V₁<V₀. Then, the relationship of operating temperature variation can be obtained as follows:

$$( 1 - \frac{Δ V}{{V}_{0}} ) \frac{{P}_{I}}{{P}_{0}} {T}_{0} < {T}_{I} < \frac{{P}_{I}}{{P}_{0}} {T}_{0} . \qquad ( 5 )$$

In other words, the effective operating temperature range is determined by

$$\frac{Δ V}{{V}_{0}} ,$$

and the larger

$$\frac{Δ V}{{V}_{0}}$$

is, the wider the operating temperature range is. When increasing the volume of lining 3, V₀ decreases and

$$\frac{Δ V}{{V}_{0}}$$

increases, which makes the gas-liquid coupling type fluid pulsation attenuator has an effect of pulsation absorbing in a wide temperature range.

In an optional embodiment of the present disclosure, the effective operating pressure range of the gas-liquid coupling type fluid pulsation attenuator is matched by adjusting the volume of lining 3. It can be explained by the following derivation.

When the temperature is constant as T₁, the following relationship can be obtained from formula (1) and formula (2).

$${P}_{I} = \frac{{V}_{0}}{{V}_{I}} {P}_{0} \qquad ( 6 )$$

When the second chamber 7 is in the state of complete expansion or complete compression, since the movement of the bladder 2 is limited, the gas in the second chamber 7 loses pulsating effect. In order to ensure that the gas-liquid coupling type fluid pulsation attenuator has pulsation reduction effect, it is needed to ensure that the bladder 2 is between the maximum volume Vₘₐₓ and the minimum volume Vₘᵢₙ, which can be described as the following relation formula.

V₀−ΔV<V₁<V₀ (7)

The relation formula of change range of operating pressure P₁ can be obtained according to the formula (6) and (7):

$${P}_{0} < {P}_{I} < \frac{1}{1 - \frac{Δ V}{{V}_{0}}} {P}_{0} . \qquad ( 8 )$$

According to the formula (8), the operating pressure P₁ is positively correlated with the variable volume

$$\frac{Δ V}{{V}_{0}}$$

of the second chamber 7, that is, the larger the change range of the variable volume

$$\frac{Δ V}{{V}_{0}}$$

is, the larger the range of the operating pressure P₁ is. When increasing the volume of lining 3, V₀ will decreases, and then

$$\frac{Δ V}{{V}_{0}}$$

increases, which makes the attenuator has an effect of pulsation absorbing in a wide pressure range.

In an optional embodiment of the present disclosure, the shape of the bladder 2 is a long cylinder, and the effective operating frequency range of the gas-liquid coupling type fluid pulsation attenuator can be matched by adjusting the volume of lining 3, which can be explained through the following derivation.

In hydraulic system, impedance Z(s) is defined as the ratio of system pressure P to flow rate Q, i.e.,

$$Z ( s ) = \frac{P}{Q} .$$

The larger the impedance value Z(s), the greater the pressure variation caused by the unit flow rate. Therefore, in the research of hydraulic attenuator, the effect of pulsation absorbing of the attenuator can be approximately characterized by the impedance Z(s) of the attenuator. That is, the greater the impedance value, the worse the pulsation absorbing effect; and the smaller the impedance value, the better the pulsation absorbing effect. Therefore, the broadband characteristics of the attenuator can be obtained through the impedance method.

For the bladder 2, the formulas (9)-(11) can be obtained through the Newton's second law.

$$\begin{matrix}{P}_{0} {A}_{0} - {P}_{I 1} {A}_{I} = m \frac{{d}^{2} x}{d {t}^{2}} & ( 9 ) \\ {Q}_{0} = {A}_{0} \frac{d x}{d t} & ( 10 ) \\ \frac{d {P}_{I 1}}{d t} = \frac{n {P}_{I 0} {A}_{I}}{{V}_{I 0}} \cdot \frac{d x}{d t} & ( 11 )\end{matrix}$$

Wherein, P_{I1} is the gas pressure, P₀ is the oil pressure, V_{I0} is the volume of the air chamber at equilibrium, P_{I0} is the gas pressure at equilibrium, A₀ is the external area of bladder 2, A₁ is the internal area of bladder 2, m is the mass of bladder 2, and x is the contraction direction of bladder 2.

Through Laplace transformation of formulas (9)-(11), formulas (12)-(14) can be obtained.

$$\begin{matrix}{P}_{0} ( s ) {A}_{0} - {P}_{I 1} ( s ) {A}_{I} = m x {s}^{2} & ( 12 ) \\ {Q}_{0} ( s ) = {A}_{0} xs & ( 13 ) \\ {P}_{I 1} ( s ) = \frac{n {P}_{I 0} {A}_{I}}{{V}_{I 0}} x ( s ) & ( 14 )\end{matrix}$$

According to the formulas (12)-(14), the impedance of the attenuator is:

$$Z ( s ) = \frac{{P}_{0} ( s )}{{Q}_{0} ( s )} = \frac{m}{{A}_{0}^{2}} s + n \frac{{A}_{I}^{2} {P}_{I 0}}{{A}_{0}^{2} {V}_{I 0}} \frac{1}{s} \qquad ( 15 )$$

Since the bladder 2 is a long cylinder, its mass m can be expressed by surface area A₀ and thickness h as m=ρA₀h, then the impedance of the attenuator can be further changed to:

$$Z ( s ) = \frac{{P}_{0} ( s )}{{Q}_{0} ( s )} = ρ \frac{h}{{A}_{0}} s + n \frac{{A}_{I}^{2} {P}_{I 0}}{{A}_{0}^{2} {V}_{I 0}} \frac{1}{s} . \qquad ( 16 )$$

Wherein,

$$ρ \frac{h}{{A}_{0}} s$$

is differential term and

$$n \frac{{A}_{I}^{2} {P}_{I 0}}{{A}_{0}^{2} {V}_{I 0} s} \frac{1}{s}$$

is integral term. The integral term means that it can absorb the pulsation of pipeline system in all frequency band whereas the differential term will lead to the increase of impedance in high frequency band. Therefore, through the design of the attenuator structure,

$$\frac{h}{{A}_{0}}$$

can be reduced which makes the effect of differential term weakened, and as a result, the wide-band pulsation absorbing performance of the attenuator can be widened. By increasing the length and diameter of lining 3, the surface area of bladder 2 can be increased,

$$\frac{h}{{A}_{0}}$$

can be reduced, and the pulsation absorbing in wide frequency range can be realized.

In an optional embodiment of the present disclosure, the lining 3 is provided with a through vent hole 31 along its radial direction to facilitate the internal gas flow of bladder 2.

In an optional embodiment of the present disclosure, further comprise:

connecting pipe 4, and one end of the connecting pipe 4 is connected to the interior of the bladder 2, and the other end of the connecting pipe 4 is connected to a plug 5 through thread, so as to convenient to inflate or exhaust.

In an optional embodiment of the present disclosure, both ends of the substrate 1 are open, and the opening of one end of the substrate 1 is sealed connected to the end of the connecting pipe 4 far away from the bladder 2. The sealing ring and other sealing elements can be set between the connecting pipe 4 and the substrate 1 to realize the sealing connection, or the connecting pipe 4 and the substrate 1 can be welded into an integral structure.

In an optional embodiment of the present disclosure, the end of the substrate 1 far away from the plug 5 is extended outwards with a connecting part 11. The connecting part 11 is provided with an external thread, and the end of the connecting part 11 far away from the substrate 1 is provided with a connecting through hole leading to the opening of the substrate 1.

In an optional embodiment of the present disclosure, the bladder 2 is made of elastic rubber.

In an optional embodiment of the present disclosure, the bladder 2 is made of oil resistant elastic rubber.

In the description of this specification, the descriptions of the terms “one embodiment/mode”, “some embodiments/modes”, “examples”, “specific examples”, or “some examples” means that the specific features, structures, materials, or characteristics described in connection with the embodiment/mode or example are included in at least one embodiment/mode or example of the present application. In this specification, the schematic expression of the above terms does not necessarily refer to the same embodiment/mode or example. Moreover, the specific features, structures, materials, or characteristics described can be combined in any suitable manner in any one or more embodiments/modes or examples. In addition, without contradicting each other, those skilled in the art may combine different embodiments/modes or examples and features of the different embodiments/modes or examples described in this specification.

In addition, the terms “first” and “second” are used for description purposes only, and cannot be understood as indicating or implying relative importance or implicitly indicating the number of technical features indicated. Thus, the features defined as “first” and “second” may include at least one of the features either explicitly or implicitly. In the description of the present application, the meaning of “plurality” is at least two, such as two, three, etc., unless specifically defined otherwise.

Those skilled in the art should understand that the above-mentioned embodiments are only for clearly illustrating the present disclosure, rather than limiting the scope of the present disclosure. For those skilled in the art, other changes or modifications can be made on the basis of the above disclosure, and these changes or modifications are still within the scope of the present disclosure.

1. A gas-liquid coupling type fluid pulsation attenuator, characterized in that, comprising:
substrate, which is hollow and with an opening at one end;
bladder, which is located at the hollow part of the substrate, and a first chamber is formed between the bladder and an inner wall of the substrate; and
lining, which is located inside the bladder.

2. The gas-liquid coupling type fluid pulsation attenuator according to the claim 1, characterized in that, the lining is provided with a through vent hole along its radial direction.

3. The gas-liquid coupling type fluid pulsation attenuator according to the claim 1, characterized in that, an effective operating temperature range of the gas-liquid coupling type fluid pulsation attenuator is matched by adjusting volume of the lining.

4. The gas-liquid coupling type fluid pulsation attenuator according to the claim 1, characterized in that, an effective operating pressure range of the gas-liquid coupling type fluid pulsation attenuator is matched by adjusting volume of the lining.

5. The gas-liquid coupling type fluid pulsation attenuator according to the claim 1, characterized in that, further comprising:
connecting pipe, and one end of the connecting pipe is connected to an interior of the bladder, and the other end of the connecting pipe is connected to a plug through thread.

6. The gas-liquid coupling type fluid pulsation attenuator according to the claim 5, characterized in that, both ends of the substrate are open, and an opening of one end of the substrate is sealed connected to an end of the connecting pipe far away from the bladder.

7. The gas-liquid coupling type fluid pulsation attenuator according to the claim 6, characterized in that, an end of the substrate far away from the plug is extended outwards with a connecting part; and the connecting part is provided with an external thread, and an end of the connecting part far away from the substrate is provided with a connecting through hole leading to the opening of the substrate.

8. The gas-liquid coupling type fluid pulsation attenuator according to the claim 1, characterized in that, the bladder is made of elastic rubber.

9. The gas-liquid coupling type fluid pulsation attenuator according to the claim 8, characterized in that, the bladder is made of oil resistant elastic rubber.

10. The gas-liquid coupling type fluid pulsation attenuator according to the claim 1, characterized in that, the shape of the bladder is a long cylinder.
